(19) United States
(12) Patent Application Publication
(10) Pub. No.: US 2017/0331909 A1
(43) Pub. Date: Nov. 16, 2017

(54) SYSTEM AND METHOD OF MONITORING AND TRACKING ONLINE SOURCE CONTENT AND/OR DETERMINING CONTENT INFLUENCERS

(71) Applicants: Jon A. Iadonisi, Plano, TX (US); Timothy W. Newberry, Plano, TX (US); Matthew Meyer, Plano, TX (US)

(72) Inventors: Jon A. Iadonisi, Plano, TX (US); Timothy W. Newberry, Plano, TX (US); Matthew Meyer, Plano, TX (US)

(73) Assignee: VIZSENSE, INC., Plano, TX (US)

(21) Appl. No.: 15/152,858

(22) Filed: May 12, 2016

(51) Int. Cl. H04L 29/08; H04L 12/26

(52) U.S. Cl. CPC H04L 67/22; H04L 43/045

(57) ABSTRACT

A system and method for tracking and interactively displaying the distribution of online source content, comprises a computer having one or more physical processors for tracking a unique online source content item, aggregating and processing data associated with the dissemination of unique online source content, and displaying aggregated processed data representing the dissemination of unique online source content and its associated influencers. In a system and method of the present invention, the top influencers are shown as nodes of varying sizes, wherein the size is a function of how many times that influencer disseminated the source content and wherein when a user clicks on a node in the interactive display, information about the influencer is displayed to the user. The interactive display may also contain curved lines representing the paths of dissemination of the source content information and may be color-coded to represent distinct influencer networks.

### RELATED APPLICATION

This application claims the benefit of U.S. Provisional Application No. 62/161,338 filed on May 14, 2015, the entire disclosure of which is incorporated herein by reference.

### COPYRIGHT NOTICE

A portion of the disclosure of this document contains material that is subject to copyright protection. The copyright owner does not object to copying this document or patent disclosure as it appears in Patent and Trademark Office records, but reserves all of its copyright rights therein.

### FIELD OF THE INVENTION

This invention relates to systems and methods for monitoring and tracking online source content through a plurality of social media networks and other online information providers. More specifically, the invention relates to systems and methods for determining source content influencers from those networks and/or online information providers.

### BACKGROUND OF THE INVENTION

There is a plurality of content such as videos, audio files, photos, text, and/or other types of content available online for users to post and share through various networks and online service providers. However, limitations exist with respect to effectively monitoring, aggregating and/or selectively displaying volumes of information (e.g. Big Data) relating to the tracking of specific online source content in a visual display that makes the information therein intuitively understandable and/or whereby content influencers are easily identifiable and visually discernable.

### SUMMARY OF THE INVENTION

In a preferred embodiment of the present invention, the system comprises a computer having one or more processors; a user interface through which a user can interact with a system of the present invention to identify online source content for tracking; a manager, which manages and monitors high-level system operations; a data collector which interacts with one or more data sources to collect tracking information about a unique online source content item, including, without limitation, the source content influencers, the paths of dissemination, the network of influence over time and any other relevant information; a data assembler which aggregates and processes the collected tracking information to determine, inter alia, the identities and characteristics of the source content influencers, the inter-relationships of the source content influencers, the reach of each source content influencer, the specific path of dissemination of the source content information, and other relevant information needed to populate preformatted templates for further consumption by the user; a visual graph builder which converts the aggregated tracking information into a visual user-friendly display so that the user can better understand the dissemination of the specified online source content and the interrelationships between the influencers of a specified online source content. In a further preferred embodiment, the system further comprises storage for the specified online source content, the aggregated tracking information, a relational database and files pertaining to each time period searched and each source content searched.

A preferred method of the present invention includes identifying online source content for tracking, interacting with at least one data source to track the identified online source content through various social media or other online platforms and/or search engines, and identifying the online influencers, the inter-relationships between social media influencers and the dissemination of that specified online source content. A preferred method of the present invention also includes generating one or more interactive graphs that display information about the relationships between the online source content and each influencer over time. Another preferred method of the present invention also includes ranking each influencer according to reach. In a system and method of the present invention, the tracking of the source content is depicted as a series of nodes each node representing a unique source content influencer with curved lines extending thereto and/or therefrom, each line representing a path of distribution originating from the source content. In a system and method of the present invention, the size of a node visually represents the extent of that influencer's reach regarding the source content. In a system and method of the present invention, by clicking on any of the nodes, information about that particular influencer represented by the node will be shown. In a system and method of the present invention, geographical information about the reach of the source content and/or some or all of the influencers can be displayed on a system-generated map.

### BRIEF DESCRIPTION OF THE DRAWINGS

FIG. 1 is a block diagram of a preferred embodiment of the system of the present invention.

FIG. 2 is a flowchart used by a preferred embodiment of the system of the present invention for selecting source content to track using an exemplary embodiment of the disclosed method of the present invention.

FIG. 3 is a flowchart used by a preferred embodiment of the system of the present invention showing the gathering data step using an exemplary embodiment of the disclosed method of the present invention.

FIG. 4 is a flowchart used by a preferred embodiment of the system of the present invention showing the data assembling and display steps using an exemplary embodiment of the disclosed method of the present invention.

FIG. 5 is an exemplary graphic visual representation of the distribution of a specific source content over time using a preferred embodiment of the system and method of the present invention.

### DETAILED DESCRIPTION OF THE DRAWINGS

As used herein, “user” refers to an entity, person or automated system that interacts with the system of the present invention via a user interface (“UI”). As used herein, “source content” shall mean, online source content the user wishes to track. The source content may be any Unique Identifying Link (URL) of an article, tweet, video, audio file, photo, text, message, post, blog entry, comment, and/or any other type of unique content that is available online for users to view, access, post and share through various websites, online social networks, virtual communities and/or other online electronic and mobile platforms. Examples of social networks, virtual communities and/or other online electronic platforms in which source content may be generated include, without limitation, Twitter, YouTube, Facebook, Google, LinkedIn, Instagram, Vimeo, Pinterest, MySpace, Flickr and others. As used herein, “data source” may be one of more of these social networks, virtual communities and/or other electronic platforms. The system and method of the present invention can track source content through any online social network, virtual community or electronic platform with suitable modifications and/or substitutions well known in the art and with the proper licenses to access and use the information in place.

As used herein, “data identifier” or “source content identifier” shall mean a unique ID that identifies specific source content, metatag or some other unique identifier. As used herein “source content influencer” shall mean a person, persona, username or other identified digital identity that facilitates electronic communications (e.g., but not limited to, an RSS feed or a widely viewed digital “bazaar”) receiving or generating data concerning the source content. As used herein, “action” shall mean an action taken by the source content distributor, such as, without limitation, receiving the source content from the original source, receiving it from another source content influencer, and/or sending the source content to one or more other source content influencer(s).

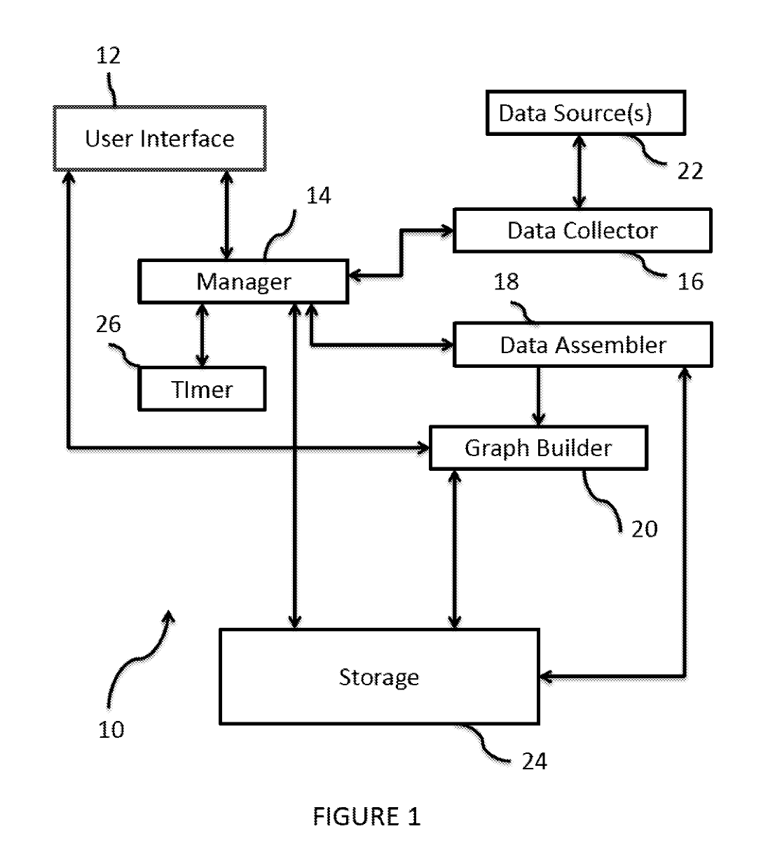

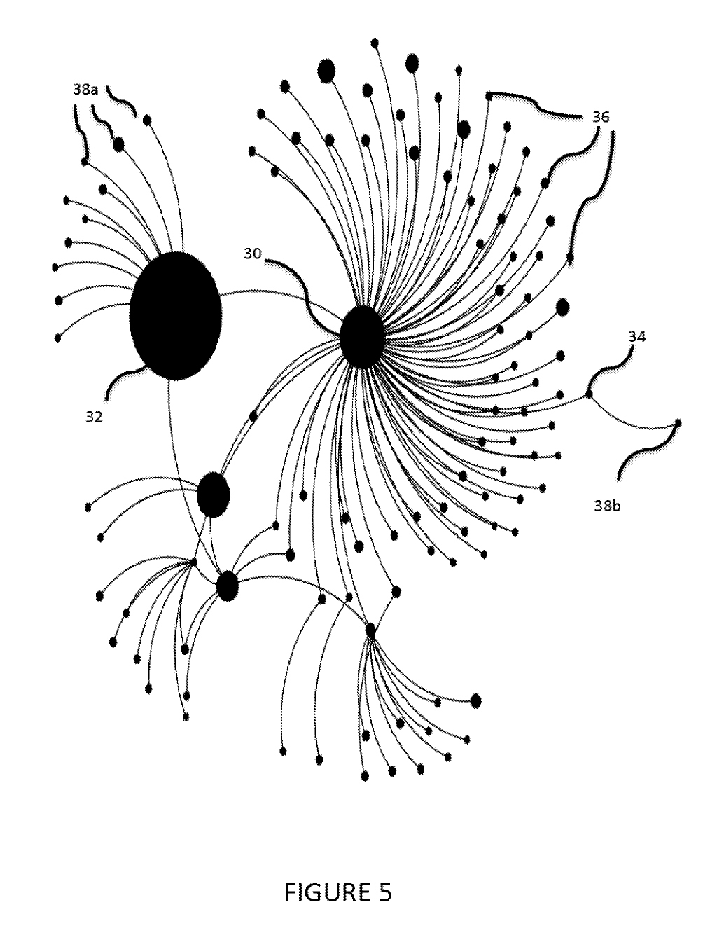

Referring first to FIG. 1, a preferred embodiment of the computer system of the present invention is shown. The computer system 10 comprises one or more computer processors or modules (not shown) that periodically execute one or more steps of the method of the present invention. In a preferred embodiment, the computer system 10 also comprises a user interface 12 which, in a preferred embodiment is a computer monitor or screen, through which a user can interact with the system to select online source content for tracking and through which the user can view interactive visual representations of the tracking of a unique source content item, such as the visual representation shown in FIG. 5, as will be discussed more fully below.

A preferred embodiment of the system 10 of the present invention further comprises a manager 14, which is located in either one of the processors or on a computer module running on a server, that manages high-level system operations and initiates the tracking of the identified online source content. A preferred embodiment of the system 10 of the present invention further comprises a data collector 16, which in a preferred embodiment is either an application loaded onto and stored in the computer or a computer module running on a server, which interacts with online data sources 22 to collect tracking information to determine the dissemination of the specified online source contents being tracked. In a preferred embodiment of the present invention, the online data sources 22 may be, but are not limited to, Facebook, Google, Twitter and/or YouTube APIs or any other data source from which tracking information may be obtained about the dissemination of specified online source content.

Continuing to refer to FIG. 1, a preferred embodiment of the system 10 of the present invention also comprises a data assembler 18, which in a preferred embodiment is either an application loaded onto and stored in the computer or a computer module running on a server, which processes and assembles the tracking information collected by the data collector to populate interactive displays for further consumption by the user. A preferred embodiment of the system 10 of the present invention further comprises a visual graph builder 20, which is either an application loaded onto and stored in the computer or a computer module running on a server, that processes the assembled tracking information and generates a visual user-friendly display such as, but not limited to, a visual depiction, similar to the one displayed in FIG. 5, so that the user can better understand the dissemination of the specified online source content, the influencers of the specified online source content, and the interrelationships between the influencers by merely looking at the visual depiction and clicking on its interactive features. For each unique source content item, the visual depiction will be different. The visual depictions of each unique source content item may also change over time.

In addition, in a preferred embodiment of the present invention, the system 10 further comprises one or more storage devices 24 that stores the aggregated tracking information; the unique online source content items being tracked; a relational database (DB), a Nosql DB, and/or a file on a file system (such as, but not limited to, Unix or the like) that represented the aggregated tracking information. A preferred embodiment of the system 10 of the present invention also comprises a timer 26 that triggers the manager 14 to start tracking specified online source content(s) with or without any additional input from the user.

In a preferred computer implemented method of the present invention, the method comprises identifying online source content for tracking. Once the online source is identified and entered into the system by the user, the computer interacts with at least one data source 22 to track the identified online source content through various social media, online platforms, created search algorithms and/or search engines. In a method of the present invention, the source content is stored within the system's memory 24 so that it may be recalled at a later time by the user and/or so that it can continue to be tracked by the system without any additional user input.

Once the data is collected from the one or more data sources 22, the collected data is processed by a data assembler 18 to identify the paths of dissemination of the source content including, without limitations, the online influencers and their inter-relationships for that specified online source content. The results are then assembled and processed by the data assembler 18 in a non-visual inter-relational taxonomy, which is capable of populating interactive templates for visual display by the visual graph builder 20. In a preferred method of the present invention, the method also includes generating one or more interactive graphs that display the collected assembled historical data about the relationships between the online source content and each influencer, over time. Another preferred method of the present invention also includes ranking each influencer according to reach. In response to a request from the user, the collected assembled data is presented on a screen in an interactive visual display such as is shown in FIG. 5, which is but one example of a graph created to represent the tracking of a unique online source content over time.

In a preferred system and method of the present invention, as shown in FIG. 5, the tracking of the source content is depicted as a series of nodes, see e.g., nodes 29, 32, 34, 36, 38a and 38b with each node representing a unique source content influencer. Lines/edges 28 extend to and/or from other nodes (representing other source content influencers), each line representing a path of distribution originating from the source content. In a system and method of the present invention, the size of the node represents the extent of that influencer's reach regarding the source content. The fact that node 32 is large signifies that that influencer has a large network reach. In a system and method of the present invention, by clicking on any of the nodes, information about that particular influencer and his/her/its social media reach will be shown. In a system and method of the present invention, demographic and/or geographical information about the reach of the source content and/or some or all of the influencers will be displayed on a system-generated map. In a preferred system and method of the present invention, the dissemination path of the online source content will be depicted as curved lines 28 extending from the nodes such as shown in FIG. 5.

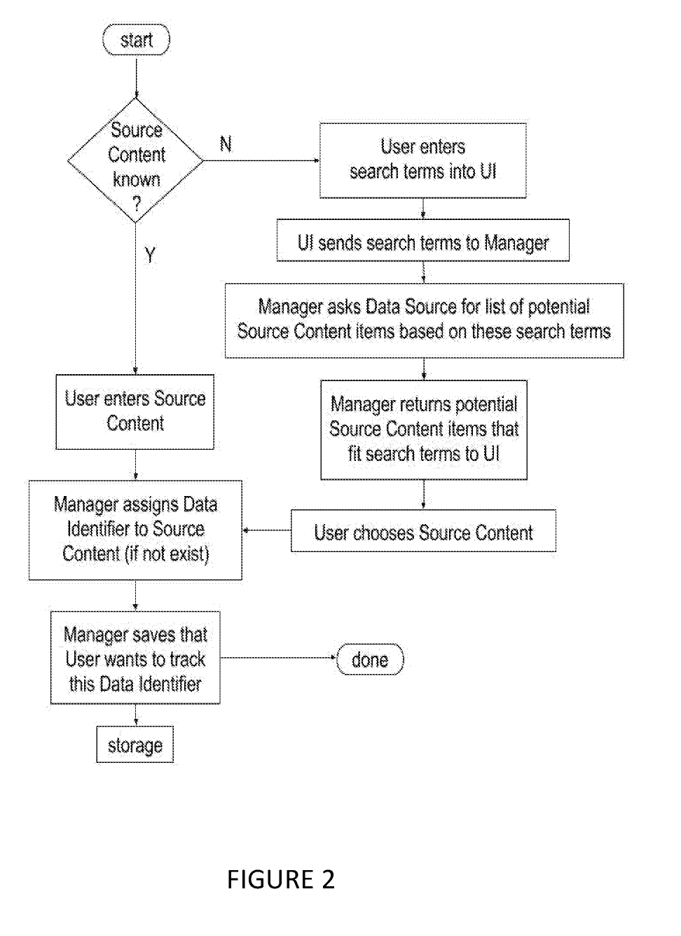

Referring more specifically to FIG. 2, a flowchart representing the initiation step of a preferred method of the present invention is shown. In order to initiate the tracking of a unique online source content, the identity of the source content needs to be entered into a preferred embodiment of the computer system of the present invention. After a user logs into the computer system 10 of the present invention, the user interface 12 asks the user to identify the unique online source content to be tracked. The unique source content may be, but is not limited to, a URL, a link, a discrete website address, a video from YouTube, a tweet, an audio file and the like. If the user knows the URL, link, discrete website address or other unique identifier of the online source content to be tracked, the user enters it into the user interface 12 for tracking. The manager 14 then assigns a data identifier to the source content if none exists.

If the user does not know the URL, link, discrete website address, etc., of the source content, the user enters search terms into the user interface 12 which sends the search request to the manager 14 of system 10. The manager then instructs the data collector 16 to search the online data sources 22 to which it has access to create a list of potential unique source content identifiers that most closely match the user's search terms. If one of the potential unique source contents is selected by the user, the manager 14 assigns a data identifier to the source content, if none exists.

In a preferred method of the present invention, once the manager identifies the unique online source content to be tracked, the manager saves the relationship data (i.e., the identity of the user for each unique online source content identifier) in the storage database.

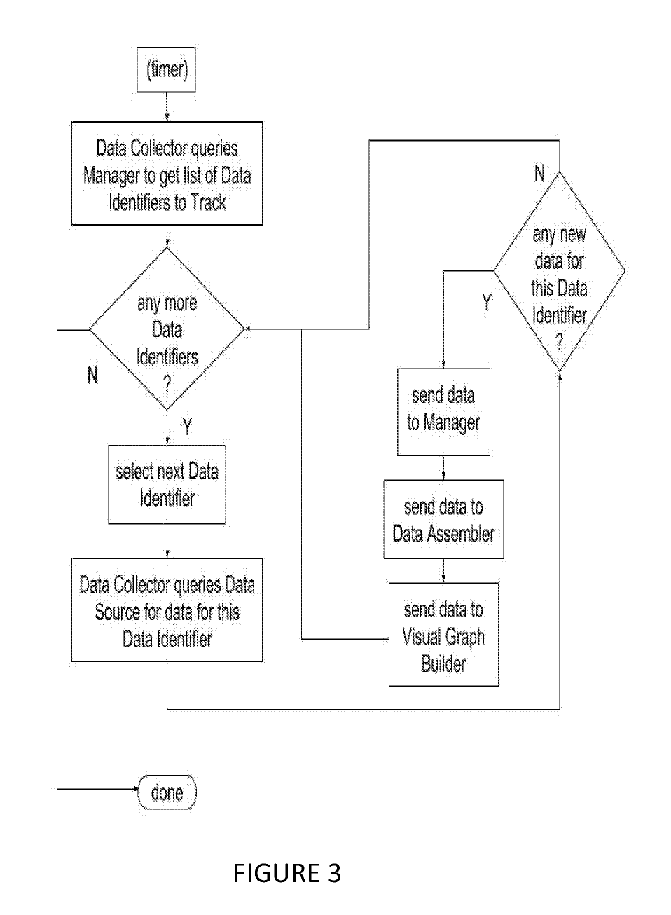

Referring next to FIG. 3, a flowchart of the gathering data step of a preferred method of the present invention is shown. In a preferred embodiment of the present invention, the manager 14 is connected to a timer 26, which is constantly running in the background. At preselected intervals, the timer 26 triggers data collection by the data collector 16 from the data sources 22 for each unique data or source content identifier to be tracked. In a preferred embodiment of the present invention data extraction may be carried out by an automated text mining processes capable of handling very high volume media data.

If no new data for this data identifier is found, then a preferred method of the present invention checks to see if there are any more data identifiers to be processed. If there are, the system selects the next data identifier to be tracked and queries the data collector 16 to obtain data from the data source 22 for that next data identifier.

If new data is found for any data identifier, then the new data is sent to the manager 14 for processing and storage. Specifically, in a preferred method of the present invention, the manager stores some of the new data in storage 24 (by way of example and not limitation, a MySQL database or any other relational database) keyed by the static (non-time-varying) data identifier. The new data that is stored by the manager 14 is time-varying data records saved according to each data identifier for each time interval set by the timer. At given intervals, data records are aggregated so that longer time periods can be represented. By way of example and not limitation, hourly data records can be combined at a specified time each day, into a daily data record; daily data records may be combined at the end of the month into a monthly data record. Using this method of the present invention, time-varying data can be later viewed using different time periods.

The manager 14 also sends aggregated data to the data assembler 18 for further processing and assembled in a non-visual inter-relational taxonomy which can then populate the visual interactive graphs produced by the visual graph builder 20. The data assembler 18 saves this processed “graph” data in storage 24 (which, in a preferred embodiment is a Nosql database or any other type of similar database or file), with each graph representing a single data identifier. This graph data has the form of interrelated nodes and edges representing interactions (which by way of example, and not limitation could be tweets) between actors (which by way of example, and not limitation could be tweeters) regarding a unique source content (which by way of example, and not limitation could be a video or a website URL). In a preferred method, graph data are not grouped into time periods, so although new data may be present for each interval, each new data record is stored with the full set and not broken out into time periods like the data stored by the manager 14 in storage 24.

Data assembler 18 then sends the graph data records to the visual graph builder 20 so that the interrelationships between influencers and their reach can be converted into visual representations. In a preferred method of the present invention, the visual representations comprise a center circle representing the unique online source content, with nodes representing each influencer connected to the center circle via curved lines, with other curved lines connecting the nodes to each other when there is an interrelationship between influencers. The size of the nodes represent the number of connections, i.e. “direct reach,” that each influencer has.

Once there are no more data identifiers to process, the gathering data steps are finished for this time period. The entire process will repeat the next the timer 26 triggers the manager to initiates the gathering of data.

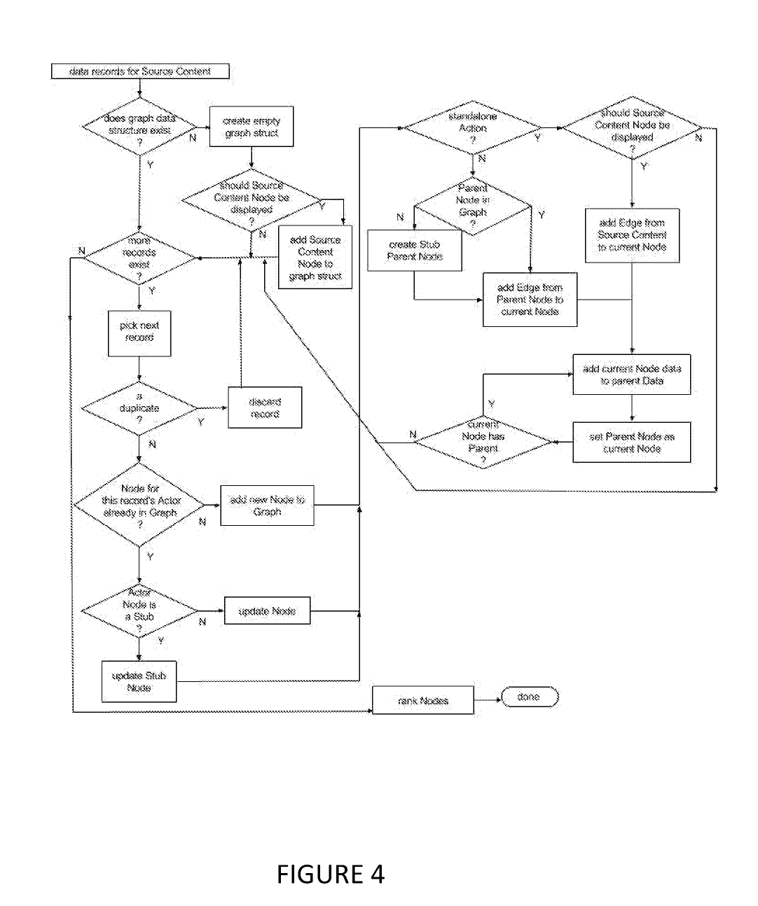

Referring next to FIG. 4, a flowchart of the data assembling and processing step of a preferred method of the present invention is shown. New data records for a tracked source content are processed and added to a non-visual graph structure that represents the interrelationships between the source content and the influencers. The graph data is used by the visual graph builder to create visual interactive graphs for the user showing the online dissemination of the source content.

In a preferred method of the present invention as shown in FIG. 4, when data records for source content are received from the manager 14, the data assembler 18 determines whether a template or other graph data structure exists for that unique online source content. If a graph data structure/template does not exist for that unique online source content, the data assembler 18 creates an empty template or other graph structure. If a source content node is to be included in the template, one is created and added to the graph. The inclusion of the source content node only affects the visual representation of the data.

Each new item of data is examined by the data assembler 18 to determine whether the influencer who is attached to the data is already represented by a node in the graph. If the influencer is not yet represented, a new node is created in the graph by the data assembler for that influencer and is checked to see if it is a duplicate item. If it is, it is discarded. If not, a node for this influencer is added to the graph. The data regarding that influencer is also examined to determine whether that influencer's node is a “stub.” As used herein, a stub is a node that represents an influencer that does not have other data associated with him/her/it, such as an influencer that has received or sent data to another influencer whose data information was processed before the current influencer's data has arrived. By way of example and not limitation, this can happen when retweet data is received before the original source tweet data. In effect, a stub is a placeholder. If the matching graph node is a stub, the stub is updated by replacing the stub with the data from the new node whereby the stub is converted to a regular node.

If an influencer in the new data record is already represented by a regular node in the graph, that node is updated with any new data regarding that influencer. By way of example and not limitation, in a preferred embodiment of the present invention, even though a node's influencer's information might not change, the list of interactions will grow as new records are added. If the action reflected in the new data record is a standalone action, which is an action that either didn't originate from or reference any other actions, and the source content node isn't being displayed, then the data assembler 18 is finished with this new data record and the next data record for this source content is processed by the data assembler. If this standalone action does have a source content node represented in the graph, then the data assembler 18 add an edge, which is a line representing the relationship between the source content node and the influencer node. For non-standalone actions, which are actions that are related to some other action, like a primary influencer sending the source content to a secondary influencer, the data assembler 18 checks to see if the primary influencer's (Parent) node exists. For non-standalone actions, which do not have the primary influencer's node in the graph, the data assembler 18 will create a stub primary influencer's node and an edge will be added from the stub primary influencer's node to the secondary influencer's (Child) node. During the aggregation step of the data assembly, which is different from the time-based data aggregation performed by the manager 14, the data for each Child node is added to the Parent node. By way of example and not limitation, if a Parent Node has a “Direct” Twitter Reach of 1000 and has 2 Child Nodes each with Direct Reaches of 100, then the Parent Node's “Network” Reach is actually 1200 (1000+100+100). This process step traverses a node's Parents, adding each node's data to each of its ancestors, respectively, until all ancestors are done. After this process is complete, the data assembly continues with the next data record until no more records exist for this source content. At that point, in a preferred method of the present invention, the nodes are ranked according to various data values, such as network reach and direct reach. These ranks are precalculated for the users so that they won't have to do time intensive calculations. Once the data assembly is complete, the graph data is saved in storage and passed along to the visual graph builder to generate a visual representation.

In a preferred display step of the present invention, the nodes are represented as circles of varying sizes (see, e.g., the circles in FIG. 5) wherein diameter of the node is determined by the number of people reached (i.e. who received the source content) from the influencer represented by that node. Curved lines are drawn from node to node. In a preferred embodiment of the present invention, the results are typically plotted in a graphical way to allow for an intuitive understanding of the influencer network. In a preferred embodiment of the present invention, the visual representations resemble exploding aerial fireworks which may resemble rosettes, horses tails, peonies, chrysanthemums, blooms, palms, spiders, waterfalls, etc.

Referring next to FIG. 5, an exemplar of a visual representation is shown. The source content 30 is represented by a circle in the middle. Each edge or curved line from the source content 30 connects the source content to its primary influencer nodes 32, 34 and 36. A primary influencer node 32 is shown directly emanating from the source content 30. As reflected by its size, this primary influencer has many people in its immediate network. A collection of secondary influencers 38a originating from the primary influencer 32 also is shown. A primary influencer 34 with only one secondary influencer 38b also is shown. Each secondary influencer is attached to his/her/its primary influencer by a curved line/edge. In a preferred embodiment of a system and method of the present invention, each primary node and the secondary nodes emanating from it will be colored the same as to identify and discern this primary influencers network as a separate and distinct network from the other networks shown on the graph, as each network will be represented by a different color.

In a preferred embodiment of the present invention, each node presented on a display screen is clickable, whereby when the node is clicked, information relating to that influencer is displayed. In a preferred embodiment, that information will include, but is not limited to, audience reach, number of friends, and geographic location, if available. In yet a further embodiment of the system and method of the present invention, the user will be able to determine the geographic location of the top influencers and their reach. In a preferred method of the present invention, the graphing step comprises assigning each node a unique color. The system and method of the present invention can also provide the top influencers, as well as each of their network reaches. In an embodiment of the present invention, the system and method maps the reach of the source content over time. In an embodiment of the present invention, the system and method can also break down the views of the source content into likes, dislikes, comments, etc. mapped over time.

In a preferred embodiment of the present invention, graphs are displayed that present aggregated details of the data that has been collected and processed using a method of the present invention. By way of example, and not limitation, for each source content, a system and method of the present invention can provide information such as, but not limited to, the name of the source content, the day it was uploaded, the reach of the source content, the total reach of the source content according to social network, the geographical location of the persons disseminating the information, and a list of the top disseminators. When, by way of example only, and not limitation, the social network being used is TWITTER, the system and method of the present invention will display the total number of persons reached, the number of tweeters who received it directly from the source and the number of persons retweeting the source contents from a direct tweeter.

When a user wishes to generate a display of the gathered data, the user requests the graphs to be displayed via the user interface 12. The user interface 12 asks the manager 14 to obtain the visual interactive graphs. The manager 14 accesses storage 24 to pull historical and aggregated and processed data received from the visual graph builder to display updated graphs. The manager then sends the graphs to the user interface 12, which then displays them on a screen for the user or makes them available for printing.

While particular embodiments and methods of the present invention have been shown and illustrated herein, it will be understood that many changes, substitutions and modifications may be made by those persons skilled in the art. It will be appreciated from the above description of presently preferred embodiments and methods that other configurations and techniques are possible and within the scope of the present invention. Thus, the present invention is not intended to be limited to the particular embodiments and methods specifically discussed hereinabove.

1. A system for tracking the online dissemination of at least one specifically identified online source content over time, the source content comprising an address for a resource on the internet represented as a URL, discrete website address, or any other existing unique identifier of online source content, so as to determine the influencers of that specifically identified online source content, comprising:
a computer comprising one or more physical processors programmed for, tracking at least one specifically identified online source content through its own online unique identifier, aggregating and processing historical data associated with the dissemination of the at least one specifically identified online source content to determine and identify the influencers of the at least one tracked specifically identified online source content and displaying the aggregated processed historical data representing the distribution and the influencers of the at least one tracked specifically identified online source content in a display, and a user interface which is displayed on a screen, through which a user can input at least one specifically identified online source content item to be tracked online into the computer and through which a user can obtain and/or interact with the displays of the aggregated and processed historical data representing the tracking of the at least one specifically identified online source content online,
wherein the interactive display displays information about the top influencers of the selected specifically identified online source content item and wherein the top influencers are shown as a graph of interconnected nodes of varying sizes on the screen, and wherein the size of the nodes are a function of how many occurrences of the specifically selected online item of-online source content were created from that influencer, and whereby when clicking on a node on the interactive display, information about the influencer represented by that node is displayed on the screen.

2. (canceled)

3. The system of claim 1, wherein at least one processor is a data assembler which assembles and processes the historical data into a non-visual inter-relational taxonomy capable of populating interactive templates for visual display which are created by a visual graph builder and which determines the relative node size.

4. The system of claim 3, further comprising a timer for periodically initiating the manager to commence tracking the at least one specifically identified online source content repeatedly over time online to create historical data regarding the distribution and the influencers of the at least one specifically identified online tracked source content wherein when data records are received, the data assembler determines whether a template or other graph data exists for that online content and, if it doesn't, creates an empty template for that source content and, if a template does exist for the source content, the data assembler determines whether the influencers attached to the new data are already represented in the template and if not, new nodes are created corresponding to the new influencer(s) in the template by the data assembler, and an influencer is already represented, the node representing that influencer is updated with any new data regarding that influencer such that the list of interactions between influencers will grow as new historical data is obtained.

5. The system of claim 1, further comprising storage capable of storing all of the specifically identified online source content being tracked, the aggregated and processed historical data for each specifically identified and tracked online source content, and the interactive visual displays of the aggregated and processed historical data for each specifically identified and tracked online source content.

6. A system for tracking the distribution of a specifically identified unique online source content online over time, the source content comprising an address for a resource on the internet such as a URL, a discrete website address, or any other existing unique identifier of online source content, to determine the influencers and distribution paths of that specifically identified unique online source content comprising:
a computer comprising one or more physical processors programmed for tracking at least one specifically identified unique online source content online, aggregating and processing historical data associated with the online distribution of the at least one specifically identified online unique source content to determine the online influencers of the tracked at least one specifically identified unique online source content, and displaying the aggregated processed historical data representing the online distribution and the online influencers of the at least one specifically identified unique source content, wherein the aggregated and processed historical data of each tracked online specific unique source-content is displayed as a graph on a screen, a user interface which is displayed on a screen through which a user can interact with the computer by inputting at least one specifically identified online source content into the user interface to track online and through which a user can obtain and interact with graphs of the aggregated and processed historical data representing the tracking of the at least one specifically identified online source content online to obtain a clickable display containing the paths of dissemination of the source content and the top influencers of the at least one specifically identified and tracked online source content,
wherein at least one such interactive graph comprises colored nodes representing each top influencer of that tracked specifically identified unique online source content and colored curved lines representing the distribution paths of that tracked online specific unique source content, whereby the distribution paths of the tracked specifically identified online source content color coded to correspond to the color of the node representing the originating influencer(s) of that path and whereby the extent of the top influencers reach is shown and whereby by clicking on any node, information about that particular influencer represented by the node will be shown.

7. The system of claim 6, wherein at least one processor comprises a timer that initiates data collection at intervals by triggering a manager, whereby, when triggered, the manager searches the storage to find all online specifically identified unique source content items to be tracked and sends a list of each specifically identified unique online source content items to be tracked online to a data collector module which interacts with at least one data source to create historical data for each online specifically identified unique source content being tracked which is then processed by the data collector module to determine whether a template or other graph data exists for that online content and if it doesn't, the data collection module creates an empty template for that source content and, if a template does exist for the source content, the data collection module determines whether an influencer that is attached to the new data is already represented in the template and if not, a new node is created in the template by the data collection module for that new influencer, and if it is already represented, the node representing that influencer is updated with any new data regarding that influencer such that the list of interactions between influencers changes as new historical data is obtained and which may then be displayed as one or more visual displays.

8. A system for tracking specifically identified online source content over time, the online source content comprising an address for a resource on the internet represented as at least one URL, discrete website address or any other existing unique identifier of online source content, to determine the influencers of that online content, comprising:
a computer comprising a storage module and one or more physical processors, comprising:
a user interface to be used by a user to specifically identify by its URL, link, tweet, video, audio file, discrete website address or any other unique existing identifier of online source content, an online source content to be tracked online,
a manager connected to the storage module and the user interface for initiating the tracking of the specifically identified online source content over time and for storing a the unique identifier for each specifically identified online source content in the storage module,
a data collector connected to the manager which, when initiated by the manager over time, requests tracking data for each specifically identified online source content stored in the storage module unique identifier from a data source and aggregates the collected data,
a data assembler connected to the storage module and the data collector for processing the collected tracking data over time and sending the collected and processed historical tracking data for each specifically identified online source content stored in the storage module to the storage module, and
a visual graph builder connected to the data assembler and the storage module for generating at least one visual representation of the historical tracking of each specifically identified online source content being tracked and for storing visual representations of the historical tracking in the storage module wherein at least one visual representation for each specifically identified source content being tracked may be accessed by a user through the user interface and displayed as nodes and lines on a screen wherein each node represents each a top influencer of that specifically identified source content and whereby each line represents a dissemination path, and wherein the relative size of the nodes represents the extent of that top influencer's reach regarding that specifically identified unique source content user interface, whereby when a user clicks on a node, information about the top influencer and the influencer's reach is shown.

9. The system of claim 8 wherein the manager further comprises a timer for periodically initiating the tracking of at least one specifically identified online source content item.

10. The system of claim 8 wherein the visual graph builder displays the visual representation of the historical data for each selected specifically identified online source content on the screen as nodes and lines emanating from the nodes, each node being displayed in a unique color corresponding to each individual influencer of that selected URL and each line representing a distribution path of that selected URL whereby the distribution paths may are color coded according to the color of the node of the originating influencer(s).

11. A computer implemented method for tracking how a specifically selected unique item of online source content is disseminated online and to determine the top influencers of that specifically selected unique item of online source content, the online source content comprising an address for a resource on the internet, comprising:
Specifically selecting a unique item of online source content from an existing URL, link, tweet, video, audio file, discrete website address or any other discreet existing online source content having its own existing unique identifier for tracking and inputting the selected online content unique identifier into the computer,
Retrieving from one or more data sources, data related to the dissemination of the specifically selected unique item of online source content by tracking its unique identifier online,
Processing the data to determine the top online influencers of the specifically selected unique item of online source content including their functional role, networks of influence and interrelationships and creating at least one visual display thereof, and
In response to a request from the user, displaying one or more interactive visual representations of the dissemination of the specifically selected unique item of online source content on a clickable screen in which the user may click on one or more individual top influencers to display their information and networks of influence, and wherein the screen displays the dissemination of the specifically identified source content as dissemination lines connected to nodes, whereby each node represents an individual top influencer of that specifically identified source content and whereby the relative size of a node represents the extent of that top influencer's reach regarding that specifically identified unique source content.

12. The method of tracking a specifically selected unique item of online source content of claim 11, further comprising, repeating the method over time to obtain a historical set of dissemination data associated with the specifically selected unique item of online source content.

13. The method of claim 12 wherein more than one specifically selected unique item of online source content may be selected for tracking, wherein each specifically selected unique item of online source content has its own existing unique identifier, and thereafter sequentially processed according to the method of claim 11 over time, such that interactive visual representations of the dissemination of each specifically selected unique item of online source content being tracked can be displayed on the screen.

14. (canceled)

15. A computer implemented method for tracking how specific items of selected online source content is are disseminated online and to determine the top influencers of each specifically selected item of online content item, comprising:
Specifically selecting at least one item of online source content which has its own unique identifier for tracking,
Retrieving from one or more data sources, data related to the dissemination of each specifically selected item of online source content,
Processing the data to determine the top influencers of each specifically selected item of online source content including their functional role, networks of influence and interrelationships, and creating at least one visual display thereof, and
Displaying one or more interactive visual representations of the dissemination of each of the specifically selected items of online source content on an interactive screen in which a user may select one or more individual top influencers to display their data and networks of influence, wherein the interactive representation of the distribution of the specifically selected item of source content is displayed as a graph on the screen wherein such graph contains different color nodes representative of each influencer of that specifically selected online source content item and different color curved lines represent the paths of distribution of that specifically selected online source content item and whereby the distribution paths may be color coded according to the color of the node of the originating influencer and whereby when clicking on a node on the interactive screen, information about the top influencer represented by that node will be displayed.

16. The computer implemented method for tracking specifically selected items of source content online of claim 11, further comprising storing the specifically selected items of source content and data related to each influencer of each of the specifically selected items of source content in a relational database whereby the nodes are ranked according to network reach and direct reach.

17. A method of tracking and displaying the dissemination of specifically identified online items over time, each online item comprising at least one address for a resource on the internet represented as a URL, discreet website address, or any other existing unique identifier of online source content using a physical computer system comprising multiple physical processors and access to online data sources, to determine the top influencers of each specifically identified online item, comprising:
selecting at least one specifically identified online item to track,
gathering data from at least one online data source over time regarding the dissemination over time of the at least one selected specifically identified online item,
aggregating and processing the historical data associated with the at least one selected source content item into a taxonomy of top influencers who have disseminated the at least one selected source content item,
displaying the sorted historical data representing the tracking of the selected specifically identified online item in an interactive clickable display on a screen wherein information about the top influencers of the selected specifically identified online item over time is shown and wherein the top influencers are shown on the screen in the display as nodes of varying sizes, wherein the size of the node is a function of how many occurrences of the specifically selected online item were created from that influencer such that the top content influencers are easily identifiable and visually discernable, 13 whereby when a node is clicked on by a user, information regarding the top influencer is displayed.

18. The method of claim 17, wherein the nodes of such display are color coded so that a different color nodes represents each influencer of that specifically selected URL and different color lines represent the dissemination paths of that specifically selected URL and whereby the dissemination paths may be color coded according to the color of the node of the originating influencer.

19. (canceled)

20. The method of claim 17 wherein the interactive display has curved lines between the nodes representing the dissemination path of the specifically selected URL.
